(19) United States
(12) Patent Application Publication
(10) Pub. No.: US 2015/0149938 A1
(43) Pub. Date: May 28, 2015

(54) PORTABLE ELECTRONIC DEVICE, METHOD FOR CHANGING MAIN PAGE AUTOMATICALLY AND COMPUTER READABLE STORAGE MEDIUM

(71) Applicant: Wistron Corporation, New Taipei City (TW)

(72) Inventor: Yu-Neng Chen, New Taipei City (TW)

(73) Assignee: Wistron Corporation, New Taipei City (TW)

(21) Appl. No.: 14/287,201

(22) Filed: May 27, 2014

(30) Foreign Application Priority Data
Nov. 27, 2013 (TW) 102143289

(51) Int. Cl. G06F 3/0483; G09G 5/00; G09G 5/14; G06F 3/0484

(52) U.S. Cl. CPC G06F 3/0483; G06F 3/0484; G09G 5/003; G09G 5/14; G09G 2354/00; G09G 2320/08; G09G 2320/10
USPC 715/762

(57) ABSTRACT

A method for changing a main page automatically is adapted for a portable electronic device. The method includes steps of setting N predetermined locations and N application groups, wherein each of the N predetermined locations is corresponding to one of the N application groups, and each of the N application groups includes at least one application; determining a current location where the portable electronic device is located on; comparing the current location with the N predetermined locations; and controlling a display unit of the portable electronic device to display an i-th application group corresponding to an i-th predetermined location in the main page when the current location is identical to the i-th predetermined location of the N predetermined locations.

### BACKGROUND OF THE INVENTION

1. Field of the Invention

The invention relates to a method for changing a main page automatically and, more particularly, to a method for changing a main page automatically according to a current location where a portable electronic device is located on.

2. Description of the Prior Art

As technology advances and develops, various portable electronic devices including a mobile phone, a personal digital assistant, a tablet computer, a notebook computer, and so on are considered a necessity by a lot of people in their daily lives. At present, a user always installs various applications in his/her portable electronic device, so as to satisfy different user needs. Due to the limited size of a display, the applications will be distributed in different pages if the user installs large applications in the portable electronic device. Since the user may use different applications at different locations, he/she needs to flip the pages manually to find the desired application. The aforesaid operation is quite inconvenient for the user.

### SUMMARY OF THE INVENTION

The invention provides a portable electronic device, a method for changing a main page automatically and a computer readable storage medium, so as to solve the aforesaid problems.

According to the claimed invention, a portable electronic device comprises a display unit for displaying a main page; a positioning unit for receiving a positioning signal; an input unit for setting N predetermined locations and N application groups, each of the N predetermined locations being corresponding to one of the N application groups, each of the N application groups comprising at least one application, N being a positive integer; and a processing unit electrically connected to the display unit, the positioning unit and the input unit, the processing unit being used for determining a current location where the portable electronic device is located on and comparing the current location with the N predetermined locations, the processing unit controlling the display unit to display an i-th application group corresponding to an i-th predetermined location in the main page when the current location is identical to the i-th predetermined location of the N predetermined locations, i being a positive integer smaller than or equal to N.

According to the claimed invention, the portable electronic device further comprises a storage unit electrically connected to the processing unit, the storage unit is used for storing a look-up table and the at least one application, and the look-up table records the N predetermined locations and the N application groups.

According to the claimed invention, a method for changing a main page automatically adapted for a portable electronic device comprises steps of setting N predetermined locations and N application groups, wherein each of the N predetermined locations is corresponding to one of the N application groups, each of the N application groups includes at least one application, and N is a positive integer; determining a current location where the portable electronic device is located on; comparing the current location with the N predetermined locations; and controlling a display unit of the portable electronic device to display an i-th application group corresponding to an i-th predetermined location in the main page when the current location is identical to the i-th predetermined location of the N predetermined locations, wherein i is a positive integer smaller than or equal to N.

According to the claimed invention, the method further comprises step of recording the N predetermined locations and the N application groups in a look-up table.

According to the claimed invention, a computer readable storage medium is used for storing a set of instructions and the set of instructions executes steps of allowing a user to set N predetermined locations and N application groups, wherein each of the N predetermined locations is corresponding to one of the N application groups, each of the N application groups includes at least one application, and N is a positive integer; determining a current location where a portable electronic device is located on; comparing the current location with the N predetermined locations; and controlling a display unit of the portable electronic device to display an i-th application group corresponding to an i-th predetermined location in a main page when the current location is identical to the i-th predetermined location of the N predetermined locations, wherein i is a positive integer smaller than or equal to N.

According to the claimed invention, the set of instructions executes step of recording the N predetermined locations and the N application groups in a look-up table.

As mentioned in the above, a user can set a plurality of locations (e.g. company, home, etc.) and a plurality of application groups corresponding to the locations in the portable electronic device. When the user carries the portable electronic device to a specific location set therein and a positioning function has been turned on, the display unit of the portable electronic device will display an application group corresponding to the specific location in the main page. Accordingly, the user can use the applications, which applications he/she often uses at the specific location, in the main page immediately without flipping the pages. Therefore, the invention can improve the convenience of operating the portable electronic device for the user.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a functional block diagram illustrating a portable electronic device according to an embodiment of the invention.

FIG. 2 is a flowchart illustrating a method for changing a main page automatically according to an embodiment of the invention.

FIG. 3 is a schematic diagram illustrating that a user carries the portable electronic device to a predetermined location.

FIG. 4 is a schematic diagram illustrating that the user carries the portable electronic device to another predetermined location.

### DETAILED DESCRIPTION

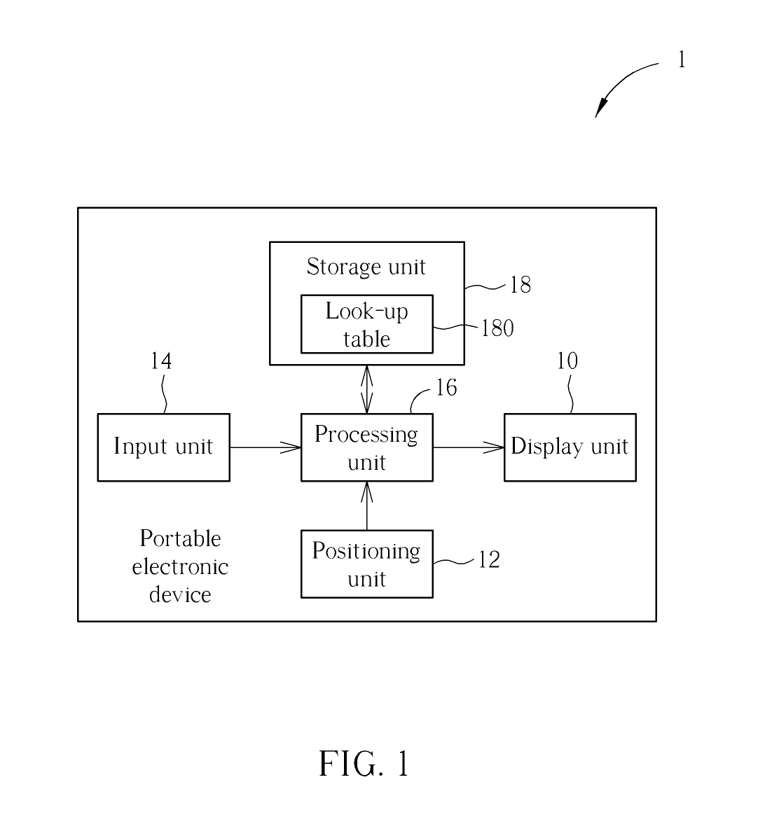

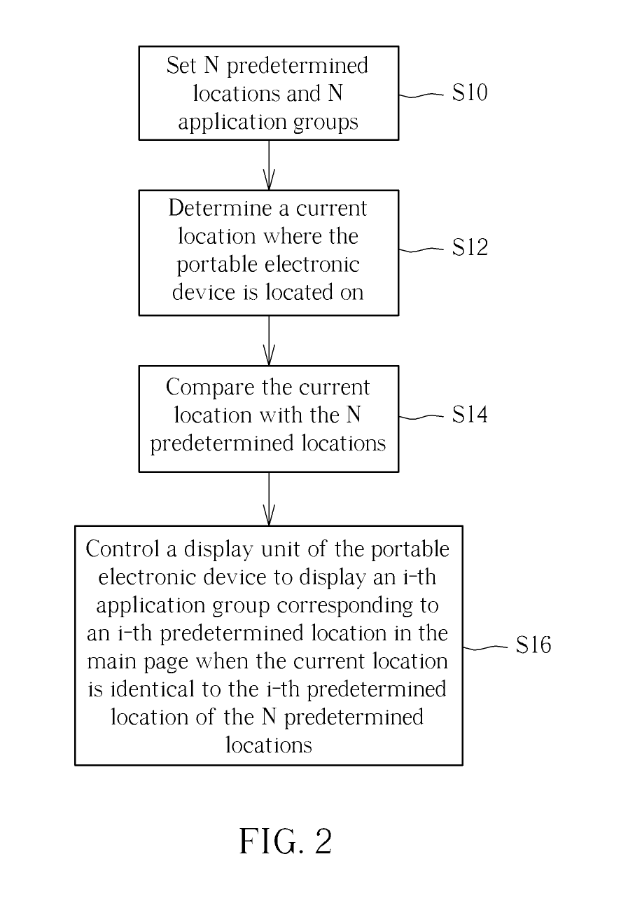

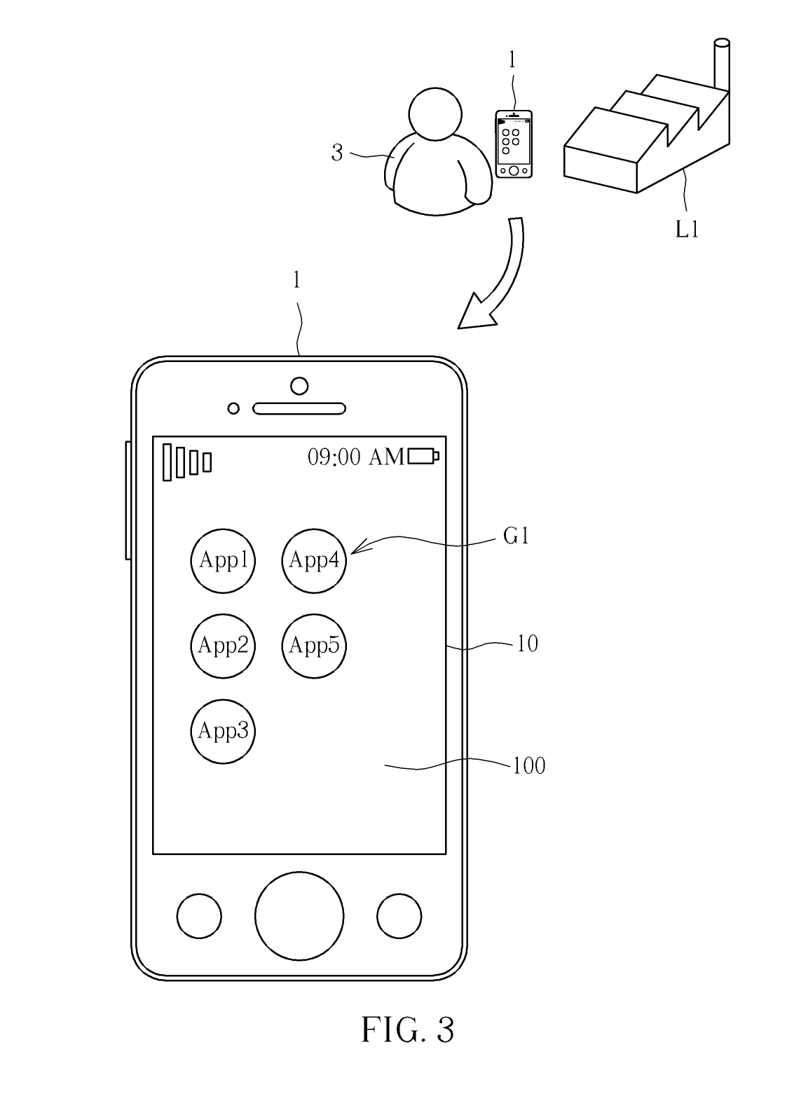

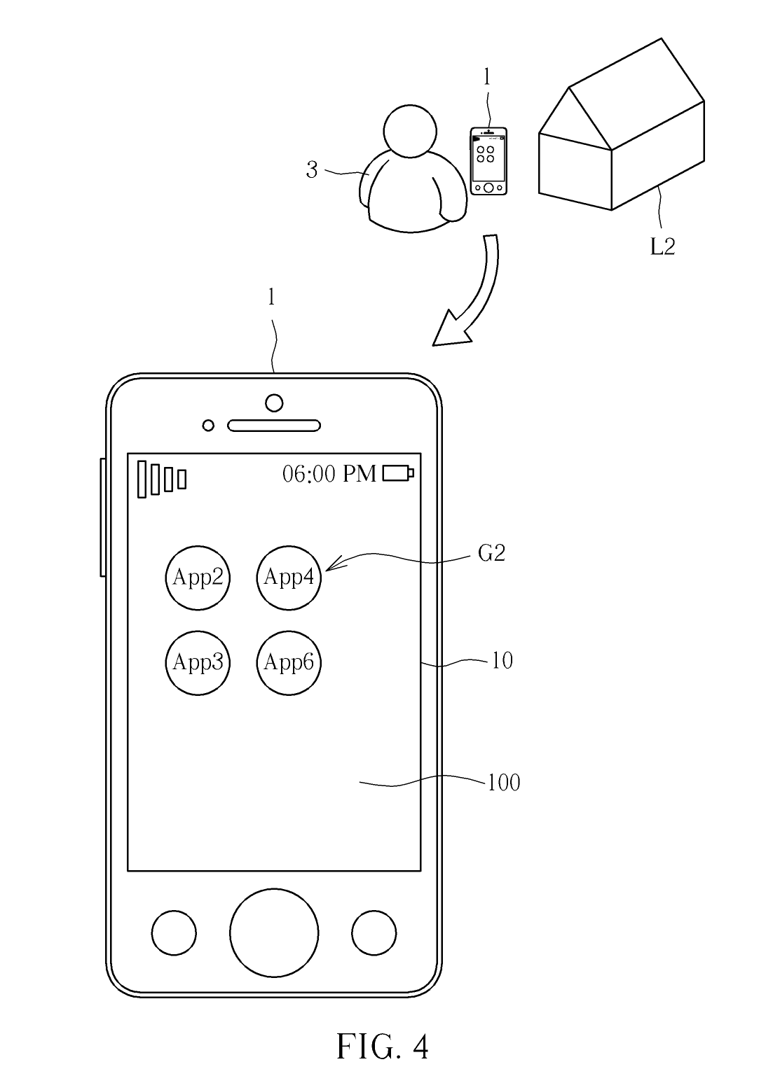

Referring to FIGS. 1 to 4, FIG. 1 is a functional block diagram illustrating a portable electronic device 1 according to an embodiment of the invention, FIG. 2 is a flowchart illustrating a method for changing a main page automatically according to an embodiment of the invention, FIG. 3 is a schematic diagram illustrating that a user 3 carries the portable electronic device 1 to a predetermined location L1, and FIG. 4 is a schematic diagram illustrating that the user 3 carries the portable electronic device 1 to another predetermined location L2. The method for changing the main page automatically shown in FIG. 2 can be implemented by the portable electronic device 1 shown in FIG. 1.

As shown in FIG. 1, the portable electronic device 1 comprises a display unit 10, a positioning unit 12, an input unit 14, a processing unit 16 and a storage unit 18, wherein the processing unit 16 is electrically connected to the display unit 10, the positioning unit 12, the input unit 14 and the storage unit 18. In practical applications, the portable electronic device 1 may be a mobile phone, a personal digital assistant, a tablet computer, a notebook computer or other electronic devices; the display unit 10 may be a liquid crystal display device or other display devices; the positioning unit 12 may be a global positioning system (GPS) or other positioning systems; the input unit 14 may be a touch panel, keyswitches or other input devices; the processing unit 16 may be a processor or controller with data calculating/processing function; and the storage unit 18 may be a hard disc, a memory or other data storage devices. In general, the portable electronic device 1 may be further equipped with some necessary hardware or software components for specific purposes, such as a power supply, an operating system, a communication module, etc., and it depends on practical applications.

The display unit 10 is used for displaying a main page 100, as shown in FIGS. 3 and 4. The positioning unit 12 is used for receiving a positioning signal. The input unit 14 is used for setting N predetermined locations and N application groups, wherein each of the N predetermined locations is corresponding to one of the N application groups, each of the N application groups comprises at least one application, and N is a positive integer. The storage unit 18 is used for storing a look-up table 180 and the at least one application, wherein the look-up table 180 records the aforesaid N predetermined locations and the corresponding N application groups.

As step S10 shown in FIG. 2, a user can operate the input unit 14 to set N predetermined locations (e.g. company, home, etc.) and N application groups in a setting interface (not shown). For example, the user can input the company address or the home address to be the aforesaid predetermined locations. The invention can records the N predetermined locations and the N application groups in the look-up table 180. Referring to table 1 below, table 1 shows that the look-up table 180 records N predetermined locations L1-Ln and N application groups G1-Gn correspondingly, wherein the application group G1 corresponding to the predetermined location L1 comprises five applications App1, App2, App3, App4 and App5, the application group G2 corresponding to the predetermined location L2 comprises four applications App2, App3, App4 and App6, the application group G3 corresponding to the predetermined location L3 comprises one application App1, . . . , and the application group Gn corresponding to the predetermined location Ln comprises six applications App4, App5, App6, App7, App8 and App9.

TABLE 1
Look-up table 180

| Predetermined | Application | |
|---|---|---|
| location | group | Application |
| L1 | G1 | App1, App2, App3, |
| | | App4, App5 |
| L2 | G2 | App2, App3, App4, |
| | | App6 |
| L3 | G3 | App1 |
| . . . | . . . | . . . |
| Ln | Gn | App4, App5, App6, |
| | | App7, App8, App9 |

Afterward, as step S12 shown in FIG. 2, the processing unit 16 determines a current location where the portable electronic device 1 is located on according to the positioning signal received by the positioning unit 12. Then, as step S14 shown in FIG. 2, the processing unit 16 compares the current location with the N predetermined locations in the look-up table 180. Finally, as step S16 shown in FIG. 2, the processing unit 16 controls the display unit 10 to display an i-th application group corresponding to an i-th predetermined location in the main page 100 when the current location is identical to the i-th predetermined location of the N predetermined locations, wherein i is a positive integer smaller than or equal to N.

As shown in FIG. 3 and table 1, when a user 3 carries the portable electronic device 1 to the predetermined location L1 and the positioning function has been turned on, the processing unit 16 will determine that the current location where the portable electronic device is located on is identical to the first predetermined location L1 in the look-up table 180. At this time, the processing unit 16 will control the display unit 10 to display the applications App1, App2, App3, App4 and App5 of the first application group G1 corresponding to the first predetermined location L1 in the main page 100. As shown in FIG. 4 and table 1, when the user 3 carries the portable electronic device 1 to another predetermined location L2 and the positioning function has been turned on, the processing unit 16 will determine that the current location where the portable electronic device is located on is identical to the second predetermined location L2 in the look-up table 180. At this time, the processing unit 16 will control the display unit 10 to display the applications App2, App3, App4 and App6 of the second application group G2 corresponding to the second predetermined location L2 in the main page 100.

It should be noted that the control logic of the method for changing the main page automatically shown in FIG. 2 can be implemented by software. The software can be executed in any portable electronic devices with the positioning function. Needless to say, each part or function of the control logic may be implemented by software, hardware or the combination thereof. Moreover, the control logic of the method for changing the main page automatically shown in FIG. 2 can be embodied by a computer readable storage medium, wherein the computer readable storage medium stores instructions, which can be executed by the portable electronic device so as to generate control command for executing corresponding function.

As mentioned in the above, a user can set a plurality of locations (e.g. company, home, etc.) and a plurality of application groups corresponding to the locations in the portable electronic device. When the user carries the portable electronic device to a specific location set therein and a positioning function has been turned on, the display unit of the portable electronic device will display an application group corresponding to the specific location in the main page. Accordingly, the user can use the applications, which applications he/she often uses at the specific location, in the main page immediately without flipping the pages. Therefore, the invention can improve the convenience of operating the portable electronic device for the user.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A portable electronic device comprising:
a display unit for displaying a main page;
a positioning unit for receiving a positioning signal;
an input unit for setting N predetermined locations and N application groups, each of the N predetermined locations being corresponding to one of the N application groups, each of the N application groups comprising at least one application, N being a positive integer; and
a processing unit electrically connected to the display unit, the positioning unit and the input unit, the processing unit being used for determining a current location where the portable electronic device is located on and comparing the current location with the N predetermined locations, the processing unit controlling the display unit to display an i-th application group corresponding to an i-th predetermined location in the main page when the current location is identical to the i-th predetermined location of the N predetermined locations, i being a positive integer smaller than or equal to N.

2. The portable electronic device of claim 1, further comprising a storage unit electrically connected to the processing unit, the storage unit being used for storing a look-up table and the at least one application, the look-up table recording the N predetermined locations and the N application groups.

3. A method for changing a main page automatically adapted for a portable electronic device comprising:
setting N predetermined locations and N application groups, wherein each of the N predetermined locations is corresponding to one of the N application groups, each of the N application groups includes at least one application, and N is a positive integer;
determining a current location where the portable electronic device is located on;
comparing the current location with the N predetermined locations; and
controlling a display unit of the portable electronic device to display an i-th application group corresponding to an i-th predetermined location in the main page when the current location is identical to the i-th predetermined location of the N predetermined locations, wherein i is a positive integer smaller than or equal to N.

4. The method of claim 3, further comprising:
recording the N predetermined locations and the N application groups in a look-up table.

5. A computer readable storage medium for storing a set of instructions, the set of instructions executing steps of:
allowing a user to set N predetermined locations and N application groups, wherein each of the N predetermined locations is corresponding to one of the N application groups, each of the N application groups includes at least one application, and N is a positive integer;
determining a current location where a portable electronic device is located on;
comparing the current location with the N predetermined locations; and
controlling a display unit of the portable electronic device to display an i-th application group corresponding to an i-th predetermined location in a main page when the current location is identical to the i-th predetermined location of the N predetermined locations, wherein i is a positive integer smaller than or equal to N.

6. The computer readable storage medium of claim 5, the set of instructions executing step of:
recording the N predetermined locations and the N application groups in a look-up table.
